(19) United States
(12) Patent Application Publication
(10) Pub. No.: US 2019/0381698 A1
(43) Pub. Date: Dec. 19, 2019

(54) SODA BOTTLE COMPRESSION DEVICE

(71) Applicant: Elpidio Lara, Antioch, TN (US)

(72) Inventor: Elpidio Lara, Antioch, TN (US)

(21) Appl. No.: 16/009,230

(22) Filed: Jun. 15, 2018

(51) Int. Cl. B29B 17/00

(52) U.S. Cl. CPC B29B 17/0052; B30B 9/3064; B29B 2017/0063

(57) ABSTRACT

A soda bottle compression device, including a body to house a soda bottle therein, a plate disposed within the body to provide pressure to an outside surface of the soda bottle such that the soda bottle compresses as the soda bottle is squeezed between the plate and an inner wall of the body, and a rotating handle to allow the plate to move towards the inner wall of the body such that the soda bottle is compressed.

### BACKGROUND

### 1. Field

The present general inventive concept relates generally to a compression device, and particularly, to a soda bottle compression device.

### 2. Description of the Related Art

As products become more and more expensive, even soda has started to increase in price. To offset costs, soda companies often provide two-liter bottles of soda at a cheaper price per ounce. However, most people cannot finish a two-liter bottle of soda in one sitting, thereby causing the soda to become flat after a certain period of time.

For most people, a flat soda tastes as awful as drinking a room temperature milkshake. Some people prefer to buy cans instead of two-liter bottles to get the most out their soda, but that can become an excessive and expensive alternative.

Therefore, there is a need for an inexpensive device to preserve carbonation within a two-liter bottle of soda.

### SUMMARY

The present general inventive concept provides a soda bottle compression device.

Additional features and utilities of the present general inventive concept will be set forth in part in the description which follows and, in part, will be obvious from the description, or may be learned by practice of the general inventive concept.

The foregoing and/or other features and utilities of the present general inventive concept may be achieved by providing a soda bottle compression device, including a body to house a soda bottle therein, a plate disposed within the body to provide pressure to an outside surface of the soda bottle such that the soda bottle compresses as the soda bottle is squeezed between the plate and an inner wall of the body, and a rotating handle to allow the plate to move towards the inner wall of the body such that the soda bottle is compressed.

The body may include a tension meter and sensor to sense the compression level of the soda bottle when it is being squeezed between the plate and the inner wall of the body, and to display the compression level of the soda bottle thereupon.

The body may include convex grooves disposed on the inner wall to protrude therefrom and to be spaced apart from each other in a vertical direction.

The plate may be disposed near an opposing inner wall opposite from the inner wall, and may move away from the opposing inner wall towards the inner wall when the rotating handle is rotated in a first direction.

### BRIEF DESCRIPTION OF THE DRAWINGS

These and/or other features and utilities of the present generally inventive concept will become apparent and more readily appreciated from the following description of the embodiments, taken in conjunction with the accompanying drawings of which:

FIG. 1 illustrates a soda bottle compression device, according to an exemplary embodiment of the present general inventive concept.

### DETAILED DESCRIPTION

Various example embodiments (a.k.a., exemplary embodiments) will now be described more fully with reference to the accompanying drawings in which some example embodiments are illustrated. In the figures, the thicknesses of lines, layers and/or regions may be exaggerated for clarity.

Accordingly, while example embodiments are capable of various modifications and alternative forms, embodiments thereof are shown by way of example in the figures and will herein be described in detail. It should be understood, however, that there is no intent to limit example embodiments to the particular forms disclosed, but on the contrary, example embodiments are to cover all modifications, equivalents, and alternatives falling within the scope of the disclosure. Like numbers refer to like/similar elements throughout the detailed description.

It is understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements present. Other words used to describe the relationship between elements should be interpreted in a like fashion (e.g., “between” versus “directly between,” “adjacent” versus “directly adjacent,” etc.).

The terminology used herein is for the purpose of describing particular embodiments only and is not intended to be limiting of example embodiments. As used herein, the singular forms “a,” “an” and “the” are intended to include the plural forms as well, unless the context clearly indicates otherwise. It will be further understood that the terms “comprises,” “comprising,” “includes” and/or “including,” when used herein, specify the presence of stated features, integers, steps, operations, elements and/or components, but do not preclude the presence or addition of one or more other features, integers, steps, operations, elements, components and/or groups thereof.

Unless otherwise defined, all terms (including technical and scientific terms) used herein have the same meaning as commonly understood by one of ordinary skill in the art to which example embodiments belong. It will be further understood that terms, e.g., those defined in commonly used dictionaries, should be interpreted as having a meaning that is consistent with their meaning in the context of the relevant art. However, should the present disclosure give a specific meaning to a term deviating from a meaning commonly understood by one of ordinary skill, this meaning is to be taken into account in the specific context this definition is given herein.

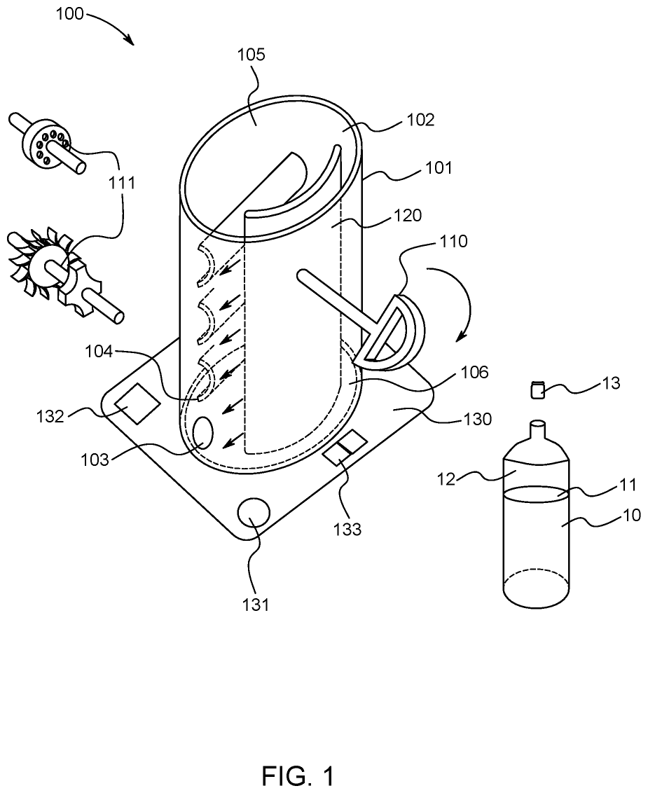

FIG. 1 illustrates a soda bottle compression device 100, according to an exemplary embodiment of the present general inventive concept.

The soda bottle compression device 100 may include a body 101, a rotating handle 110, a plate 120, and a base 130.

The body 101 may have any shape, but preferably may have a cylindrical shape to allow a soda bottle 10 to be housed therein, and may be made from metal, plastic, wood, rubber, glass, or any other material of combination on materials known to one of ordinary skill in the art. The soda bottle 10 is typically constructed from plastic for easy deformation.

The body 101 may include an opening 102 disposed at a top portion of the body 101 to allow the soda bottle 10 to be inserted therein.

The body 101 may also include a tension meter and/or sensor 103 to sense a tension level and/or compression level of the soda bottle 10 when it is being squeezed between the plate 120 and an inner wall 105 of the body 101.

The inner wall 105 may also include convex grooves 104 disposed thereon in a direction parallel to the base 130, in order to distribute compression pressure along a length of the soda bottle 10 in a lateral direction. More specifically, the convex grooves 104 may be provide in plurality, and may be disposed on the inner wall 105 to protrude therefrom and to be spaced apart from each other in a vertical direction.

As such, the plate 120 may be disposed on an opposing inner wall 106, disposed opposite from the inner wall 105.

A ratchet 111, illustrated as two different examples of ratchets in FIG. 1, may be attached between the handle 110 and the plate 120, to allow the plate to move towards and away from the inner wall 105 when the handle is rotated.

When the handle 110 is rotated in a first direction (e.g., clockwise), the plate 120 may move away from the opposing inner wall 106 towards the inner wall 105. Likewise, when the handle 110 is rotated in a second direction (e.g., counter-clockwise), the plate 120 may move towards from the opposing inner wall 106 and away from the inner wall 105.

The base 130 may support the body 101 thereupon, and may include a battery compartment to house a battery 131, as well as an outlet 132 to allow electric power to be supplied to the soda bottle compression device 100. In other words, the handle 110 may be rotated electronically in the first and second directions when the switch 133 is pressed in first and second directions.

As such, the plate 120 disposed within the body 101 to provide pressure to an outside surface of the soda bottle 10 such that the soda bottle 10 compresses as the soda bottle 10 is squeezed between the plate 120 and the inner wall 105 of the body 101.

Also, the tension meter and/or sensor 103 may sense the tension level and/or compression level of the soda bottle 10 when it is being squeezed between the plate 120 and the inner wall 105 of the body 101. Specifically, the tension meter and/or sensor 103 may sense the tension level and/or compression level of the soda bottle 10, and display the tension level and/or compression level of the soda bottle 10 on a display of the tension meter and/or sensor 103 as a digital readout. As such, the tension meter and/or sensor 103 may indicate when the soda bottle 10 is adequately compressed, in order to allow the soda bottle 10 to maintain carbonation of soda 11 disposed therein.

In other words, after a user drinks some of the soda 11, thereby leaving space 12 within the soda bottle 10, the soda bottle 10 may be placed inside the body 101 to allow the plate 120 to compress the soda bottle 10 to a compression level that maintains a proper carbonation level of the soda 11. Therefore, the soda bottle 10 may be compressed between the plate 120 and the inner wall 105, and the convex grooves 104 may be provided on the inner wall to provide further compression to the soda bottle 10.

After the soda bottle 10 is fully compressed to an appropriate level, a cap 13 may be applied to a top of the soda bottle 10 to keep the carbonation level of the soda 11.

Although a few embodiments of the present general inventive concept have been shown and described, it will be appreciated by those skilled in the art that changes may be made in these embodiments without departing from the principles and spirit of the general inventive concept, the scope of which is defined in the appended claims and their equivalents.

1. A soda bottle compression device, comprising:
a body to house a soda bottle therein;
a plate disposed within the body to provide pressure to an outside surface of the soda bottle such that the soda bottle compresses as the soda bottle is squeezed between the plate and an inner wall of the body; and
a rotating handle to allow the plate to move towards the inner wall of the body such that the soda bottle is compressed.

2. The soda bottle compression device of claim 1, wherein the body comprises:
a tension meter and sensor to sense the compression level of the soda bottle when it is being squeezed between the plate and the inner wall of the body, and to display the compression level of the soda bottle thereupon.

3. The soda bottle compression device of claim 1, wherein the body comprises:
convex grooves disposed on the inner wall to protrude therefrom and to be spaced apart from each other in a vertical direction.

4. The soda bottle compression device of claim 1, wherein the plate is disposed near an opposing inner wall opposite from the inner wall, and moves away from the opposing inner wall towards the inner wall when the rotating handle is rotated in a first direction.
